(19) United States
(12) Patent Application Publication
(10) Pub. No.: US 2023/0153809 A1
(43) Pub. Date: May 18, 2023

(54) EVENT MANAGING METHOD, RECORDING MEDIUM AND COMPUTING DEVICE

(71) Applicant: LINE Plus Corporation, Seongnam-si (KR)

(72) Inventors: Ik Hun UM, Seongnam-si (KR); Seong Woon LEE, Seongnam-si (KR); Baek Bun PYUN, Seongnam-si (KR)

(73) Assignee: LINE Plus Corporation, Seongnam-si (KR)

(21) Appl. No.: 18/151,130

(22) Filed: Jan. 6, 2023

Related U.S. Application Data
(63) Continuation of application No. 17/096,218, filed on Nov. 12, 2020.

(30) Foreign Application Priority Data
Nov. 14, 2019 (KR) 10-2019-0145663

(51) Int. Cl. G06Q 20/38; H04L 51/046; G06Q 20/08; G06Q 20/32; G06Q 20/42

(52) U.S. Cl. CPC G06Q 20/386; H04L 51/046; G06Q 20/085; G06Q 20/326; G06Q 20/425

(57) ABSTRACT

Event managing methods, computer-readable recording mediums having recorded thereon a computer program for executing the method, and/or computing devices are disclosed. The event managing method may include generating an event-associated message for participation in an event based on an input of a host user, transmitting the event-associated message to a guest user device of a guest user belonging to a first chat room through the first chat room, to which the host user belongs, transmitting a remittance request message to the guest user device based on an input of the guest user responding to the event-associated message, and determining whether remittance requested by the remittance request message has been processed by the guest user device.

### CROSS REFERENCE TO RELATED APPLICATION

The present application is a continuation of U.S. application Ser. No. 17/096,218, filed on Nov. 12, 2020, which claims priority to Korean Patent Application No. 10-2019-0145663 filed Nov. 14, 2019, the entire contents of each of which are incorporated herein for all purposes by reference.

### BACKGROUND

### 1. Field

The present disclosure relates to event managing methods performed by a computing device, recording mediums and/or computing devices, and, more particularly, to event managing methods performed by a user device (hereinafter referred to as a “host user device”) of a host user and/or a server, recording mediums having recorded thereon a program enabling a computer device to execute the event managing method, and/or computing devices for performing the event managing method.

### 2. Description of the Related Art

Recently, the use of instant messenger applications is increasing as a means of communication between users. The instant messenger application supports communication through a group chat room, to which two or more users belong. The group chat room may also be used to notify a plurality of users belonging to the chat room of various events (instant meetings, regular meetings, seminars, etc.).

If there is a participation fee (e.g., membership fee) for a specific event, participation in the event may be approved for only users who have paid the membership fee. Accordingly, a user (host user) hosting the event needs to determine whether the users (guest users) who have applied for participation in the event have paid their membership fees. Therefore, there is a need for a method capable of efficiently managing remittance of membership fees for the notified event through an instant messenger application.

### SUMMARY

Some example embodiments of the present disclosure provide an event managing method of creating an event and managing a membership fee by a user device and/or a server.

Some example embodiments of the present disclosure provide an event participation method of applying for participation in an event and paying a membership fee through a messenger application installed in a user device.

Some example embodiments of the present disclosure provide a computing device for performing an event managing method or an event participation method according to the present disclosure.

Some example embodiments of the present disclosure provide a computer-readable recording medium having recorded thereon a program for executing an event managing method or an event participation method according to the present disclosure.

The technical problems solved by the present disclosure are not limited to the above technical problems. Other technical problems which are not described herein will become apparent to those skilled in the art (hereinafter referred to as an ordinary technician) from the following description.

According to an example embodiment, an event managing method performed by a computing device comprising at least one processor may include generating an event-associated message for participation in an event based on an input of a host user, transmitting the event-associated message to a guest user device of a guest user belonging to a first chat room through the first chat room, to which the host user belongs, transmitting a remittance request message to the guest user device based on an input of the guest user responding to the event-associated message, and determining whether a remittance requested by the remittance request message has been processed by the guest user device.

In the event managing method, the event-associated message or the remittance request message may include information on a participation fee of the event or a due date for the remittance.

In the event managing method, the remittance request message may be transmitted to the guest user device through a second chat room, to which the guest user belongs, and the second chat room may be different from the first chat room.

In the event managing method, the transmitting the remittance request message may include generating a second chat room, to which the host user and the guest user belong, and transmitting the remittance request message through the second chat room.

The event managing method may further include transmitting, to the guest user device, a subsequent message based on whether the remittance has been processed.

In the event managing method, the subsequent message may be a reminder message, when the remittance has not been processed.

In the event managing method, the subsequent message may be a remittance confirmation message, in response to the remittance having been processed.

In the event managing method, the remittance confirmation message may include approval information for approving the participation in the event.

In the event managing method, information on whether the remittance requested by the remittance request message has been processed may be provided to a host user device.

According to an example embodiment, a computing device may include at least one processor that is configured to generate an event-associated message for participation in an event based on an input of a host user, transmit the event-associated message to a guest user device of a guest user belonging to a first chat room through the first chat room, to which the host user belongs, transmit a remittance request message to the guest user device based on an input of the guest user responding to the event-associated message, and determine whether a remittance requested by the remittance request message has been processed by the guest user device.

In the computing device, the event-associated message or the remittance request message may include information on a participation fee of the event or a due date for the remittance.

In the computing device, the processor may be configured to transmit the remittance request message to the guest user device through a second chat room, to which the guest user belongs, and the second chat room may be different from the first chat room.

In the computing device, the processor may be configured to generate a second chat room, to which the host user and the guest user belong, and transmit the remittance request message through the second chat room.

In the computing device, the processor may be further configured to transmit, to the guest user device, a subsequent message based on whether the remittance has been processed.

In the computing device, the processor may be configured to transmit a reminder message as the subsequent message, in response to the remittance having not been processed.

In the computing device, the processor may be configured to transmit a remittance confirmation message as the subsequent message, in response to the remittance having been processed.

In the computing device, the remittance confirmation message may include approval information for approving the participation in the event.

In the computing device, the processor is further configured to provide information on whether the remittance requested by the remittance request message has been processed to a host user device.

According to an example embodiment, an event participation method performed by a messenger application installed in a guest user device may include receiving an event-associated message for participation in an event transmitted from a host user to a guest user through a first chat room, to which the host user and the guest user belong, receiving an input of the guest user responding to the event-associated message, receiving a remittance request message transmitted to the guest user on the basis of the input of the guest user, and receiving a subsequent message transmitted to the guest user based on whether a remittance requested by the remittance request message has been processed.

In the event participation method, the event-associated message or the remittance request message may include information on a participation fee of the event or a due date for the remittance.

In the event participation method, the remittance request message may be received through a second chat room, to which the guest user belongs, and the second chat room may be different from the first chat room.

In the event participation method, the remittance request message may be received through the second chat room generated to include the host user and the guest user.

In the event participation method, the remittance request message may be received through the first chat room.

In the event participation method, the subsequent message may be a reminder message, when the remittance has not been processed.

In the event participation method, the subsequent message may be a remittance confirmation message, when the remittance has been processed.

In the event participation method, the remittance confirmation message may include approval information for approving the participation in the event.

According to an example embodiment, a guest user device may include at least one processor to perform an event participation method by a messenger application. The processor may be configured to receive an event-associated message for participation in an event transmitted from a host user to a guest user through a first chat room, to which the host user and the guest user belong, receive an input of the guest user responding to the event-associated message, receive a remittance request message transmitted to the guest user on the basis of the input of the guest user, and receive a subsequent message transmitted to the guest user based on whether remittance requested by the remittance request message has been processed.

According to an example embodiment, there is provided a non-transitory computer-readable recording medium having recorded thereon a program for execution by at least one processor included in a computing device that when executed by the at least one processor cause the computing device to perform the event managing method or the above event participation method.

According to some example embodiments, it is possible to provide an event managing method of creating an event and managing a membership fee by a user device and/or a server.

According to some example embodiments, it is possible to provide an event participation method of applying for participation in an event and paying a membership fee through a messenger application installed in a user device.

According to some example embodiments, it is possible to provide a computing device for performing an event managing method or an event participation method.

According to some example embodiments, it is possible to provide a computer-readable recording medium having recorded thereon a program for execution by at least one processor included in a computing device that when executed by the at least one processor cause the computing device to perform an event managing method or an event participation method.

It will be appreciated by ordinary technicians that the effects that can be achieved through the present disclosure are not limited to what has been particularly described hereinabove and other advantages of the present disclosure will be more clearly understood from the detailed description.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a system in which an event managing method or an event participation method according to an example embodiment of the present disclosure may be performed;

FIGS. 2A and 2B are block diagrams showing a user device and a server for performing an event managing method or an event participation method according to an example embodiment of the present disclosure;

FIG. 3 is a view illustrating an event managing method according to an example embodiment of the present disclosure;

FIG. 4 is a view illustrating an event participation method according to an example embodiment of the present disclosure;

FIG. 5 is a view showing an example of an event-associated message and a remittance request message according to an example embodiment of the present disclosure;

FIG. 6 is a view showing a reminder message and a remittance confirmation message transmitted according to an example embodiment of the present disclosure; and

FIG. 7 is a view showing a list of guest users which may be provided to a host user according to an event managing method of an example embodiment of the present disclosure.

### DETAILED DESCRIPTION

Hereinafter, some example embodiments of the present disclosure will be described in detail with reference to the accompanying drawings to the extent that the present disclosure can be easily carried out by those skilled in the art. However, the present disclosure may be embodied in various forms and should not be construed as being limited to the example embodiments described herein.

In describing the example embodiments, well-known functions or constructions will not be described in detail when it is determined that they may obscure the spirit of the present disclosure. Further, components not associated with the present disclosure are not shown in the drawings and like reference numerals are given to like components.

It is to be understood in the following description that when one component is referred to as being “connected to”, “combined with”, or “coupled to” another component, the expression may include not only direct connection but also indirect connection between the components. It will be further understood that when a component “comprises” or “has” another component, it means that the component may further include another component, not excluding another component unless stated otherwise.

It will be understood that, although the terms “first”, “second”, etc. may be used herein to describe various components, these components should not be limited by these terms. These terms are only used to distinguish one component from another component. Accordingly, within the description of the present disclosure, a first component in one embodiment may be referred to as a second component in another embodiment, and likewise a second component in one embodiment may be referred to as a first component in another embodiment.

In the following description, components are discriminated from each other to clearly describe their characteristics, but it does not mean that they are necessarily physically separated. That is, a plurality of components may be integrated in one hardware or software module and one component may be divided into a plurality of hardware or software modules. Accordingly, an integrated form of different components or divided forms of one component fall within the scope of the present disclosure even though not specifically stated.

In the following description, components described in various embodiments may not be all necessarily required but some components may be optional. Accordingly, an embodiment composed of a subset of the components included in an arbitrary embodiment also falls within the scope of the present disclosure. Further, an embodiment resulting from adding at least one component to a certain embodiment described above also falls within the scope of the present disclosure.

In addition, in this specification, the term “network” is a concept including both cable networks and wireless networks. The network refers to a communication network through which data can be exchanged between a device and a system or between devices and is not limited to a specific network.

In the present specification, the device may be a stationary device such as a home appliance equipped with a personal computer (PC) function or a display function or may be a mobile device such as a smartphone, a tablet PC, a wearable device, and a head mounted display (HMD) device. Alternatively, the device may be a computing device, a vehicle, or an Internet of Things (IoT) device each of which is operable as a server. That is, in the present specification, the device refers to any kind of device capable of performing a method of managing event of the present invention and is not limited to a specific type.

### Configuration of System and Device

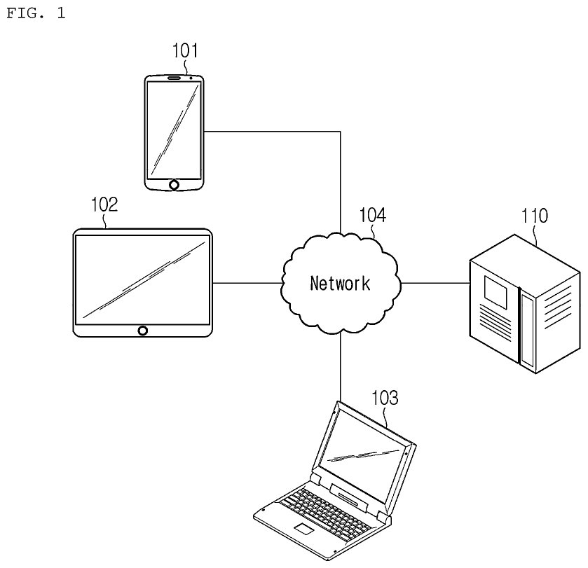

FIG. 1 is a view showing a system in which an event managing method or an event participation method according to an example embodiment of the present disclosure may be performed.

The system according to the present disclosure may include one or more user devices 101, 102 and 103 and a server 110 connected through a network 104.

The user devices 101, 102 and 103 may be referred to as client or user terminals, and may access the server 110 through the network 104 to transmit and receive data to and from the other user devices or the server.

The event managing method or the event participation method of the present disclosure may be performed using an instant messaging service. In each of the user devices 101, 102 and 103, a client module for utilizing the instant messaging service may be installed. Further, in the server 110, a server module supporting the instant messaging service may be installed. In the present disclosure, a messenger application installed in the user device may mean a client module installed in each of the user devices 101, 102 and 103 for use of the instant messaging service.

The server 110 may provide a service such as an instant messenger application. A user who uses the service may input desired (or alternatively predetermined) access information (ID and password) through the user device to access the server 110 for providing the service. The server 110 may identify users who have accessed through access information received from the user device. Further, the server 110 may collect, accumulate, store or query information on the identified users or support data transmission and reception between the identified users.

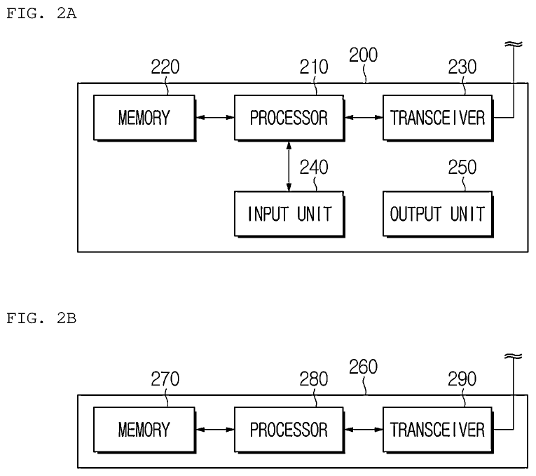

FIGS. 2A and 2B are block diagrams showing a user device and a server for performing an event managing method or an event participation method according to an example embodiment of the present disclosure.

Referring to FIG. 2A, the user device 200 may include a processor 210, a memory 220, a transceiver 230, an input unit 240 and an output unit 250. The user device 200 may further include other components related to operation and function of the device, without being limited to the above-described example embodiment.

The processor 210 may control operation of the other components in the user device 200. For example, the processor 210 may process information acquired through the input unit 240 and the transceiver 230. Further, the processor 210 may read and process information stored in the memory 220. The processor 210 may output the processed information through the output unit 250, store the processed information in the memory 220 or transmit the processed information to the outside through the transceiver 230.

For example, the processor 210 may receive, through the transceiver 230 or the input unit 240, or read, from the memory 220, all event information such as event creation information, event participation application information, event participation fee remittance information and event participation approval information. Further, after the event information is processed, the processor 210 may store the processed information in the memory 220, transmit the processed information to the outside through the transceiver 230 or output the processed information through the output unit 250.

The memory 220 may store information acquired from the outside of the user device, such as information received from the server 110 or the other user devices through the transceiver 230 or information acquired through the input unit 240 of the user device. Further, the memory 220 may store information generated inside the user device 200. For example, information generated by performing the event managing method or event participation method according to the present disclosure may be stored in the memory 220. For example, the memory 220 may include a database.

The transceiver 230 may exchange data with the server 110 or the other user devices through the network. The transceiver 230 may include all kinds of wired/wireless communication modules capable of performing communication with the outside.

The input unit 240 may include input portions implemented as various sensors or mechanical buttons provided in the user device 200. The user device 200 may include, for example, an input portion (for example, a virtual keyboard displayed on a touchscreen) using a pressure detection sensor or a capacitive touch sensor, or a mechanical button. as the input unit 240. The user device 200 may acquire information detected by the sensor or input of the mechanical button as input information.

The output unit 250 may output information acquired or received by the user device 200, information processed by the user device 200, etc. to the outside. The output unit 250 may include, for example, a display for outputting visual information. Referring to FIG. 2B, the server 260 may include a processor 280, a memory 270 and a transceiver 290. The server 260 may further include other components related to operation of the server or the system, without being limited to the above-described embodiment.

The processor 280 may control operation of the other components in the server 260. For example, the processor 280 may process information acquired through the transceiver 290. Further, the processor 280 may read and process information stored in the memory 270. The processor 280 may store the processed information in the memory 270 or output the processed information to the outside through the transceiver 290.

For example, the processor 280 may receive, through the transceiver 290, or read, from the memory 270, all event information such as event creation information, event participation application information, event participation fee remittance information and event participation approval information. Further, after the event information is processed, the processor 280 may store the processed information in the memory 270 or transmit the processed information to the outside through the transceiver 290.

The memory 270 may store information received from the outside through the transceiver 290. In addition, the memory 270 may store information generated inside the server 260. For example, information generated by performing the event managing method or event participation method according to the present disclosure may be stored in the memory 270. For example, the memory 270 may include a database.

The transceiver 290 may exchange data with another server or the user device connected to the network. The transceiver 290 may include all kinds of wired/wireless communication modules capable of performing communication with the outside.

The user device and/or server of the present disclosure may be an example of a computing apparatus or a computing device.

### Event Managing Method

In the present disclosure, a host user means a user who creates, announces or manages an event. Further, a guest user means a user who will participate in the announced event.

The event managing method according to an example embodiment of the present disclosure may be performed through a messenger application installed in a host user device.

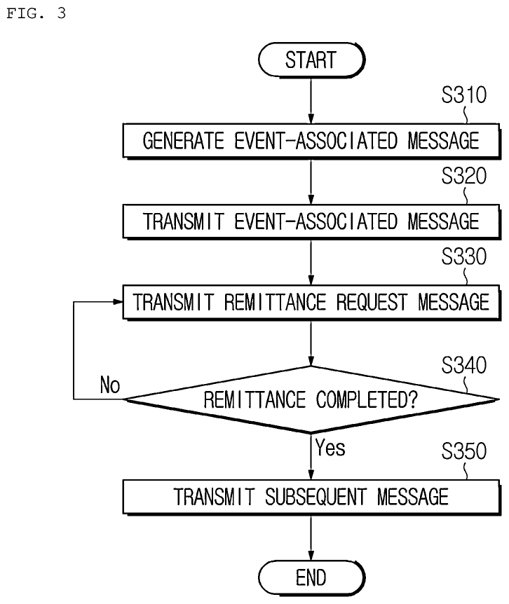

FIG. 3 is a view illustrating an event managing method according to an example embodiment of the present disclosure.

The event managing method according to an example embodiment of the present disclosure may include generating an event-associated message (S310), transmitting the event-associated message (S320), transmitting a remittance request message (S330), checking remittance completion (S340) and/or transmitting a subsequent message (S350).

The event managing method according to an example embodiment, the event-associated message related to participation in a desired (or alternatively, predetermined) event may be generated based on an input of the host user (S310).

The host user may execute, for example, a messenger application installed in a host user device or an event creation function among functions provided in an individual chat room of the messenger application, in order to create an event. When event creation starts, the host user device may receive information on an event to be created from the host user through the input unit 240. When an input of the information on the event is completed, the processor 210 of the user device may generate the event-associated message based on the input information.

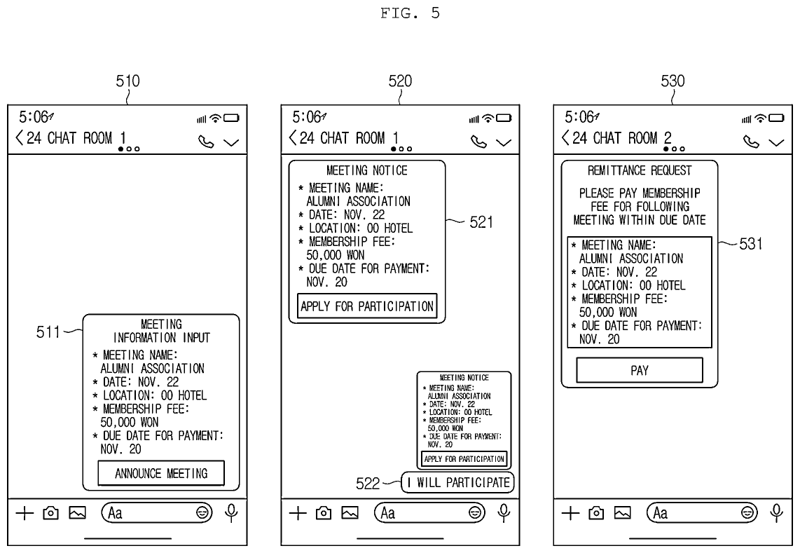

FIG. 5 is a view showing an example of an event-associated message and a remittance request message according to an example embodiment of the present disclosure.

The left chat window 510 of FIG. 5 is an example of a chat window of a host user who creates an event. For example, as shown in the left chat window 510 of FIG. 5, the host user may execute an event creation function provided in a messenger application or an individual chat room and then input information 511 on an event. The information on the event may include, for example, information on the name, date, location, membership fee and due date for payment of an event (meeting). The host user may instruct generation of the event-associated message, by inputting (clicking) a button such as “announce meeting” shown in FIG. 5 after inputting the information on the event. When input of the host user instructing generation of the event-associated message is received, the processor 210 of the user device may generate the event-associated message based on the information on the event input by the host user.

The event-associated message generated in operation S310 may be transmitted to guest users belonging to a first chat room through the first chat room. At this time, the first chat room refers to a chat room in which the host user and one or more guest users participate.

The processor 210 of the host user device may transmit the generated event-associated message to another user device (guest user device) connected to the network through the transceiver 230.

A middle chat window 520 of FIG. 5 is an example of a chat window of a guest user who receives the event-associated message 521. As shown in FIG. 5, the transmitted event-associated message 521 may be displayed on the chat window 520 of the guest user, thereby being announced to the guest users belonging to the first chat room.

The event-associated message 521 may include the information on the event input by the host user. Further, the event-associated message 521 may include, for example, a “participation application” button as a unit for receiving a guest user's intention to participate. However, the present disclosure is not limited thereto. According to some example embodiments, the event-associated message 521 may include a link related to participation application or a guide related to participation application, instead of the “participation application” button.

As shown in FIG. 5, when the event-associated message 521 is provided to a guest user, input regarding participation in the event may be received from the guest user. For example, a guest user who wants to participate in the event may input (e.g., click) the “participation application” button of the event-associated message 521, thereby inputting an intention to participate. When the link related to participation application is provided instead of the “participation application” button, the guest user may click the link and input an intention to participate according to a desired (or alternatively, predetermined) procedure required by a site connected to the link. In some example embodiments, as shown by reference numeral 522 of FIG. 5, the intention to participate in the event may be input using a reply (comment) function for the event-associated message 521. A method of inputting the intention to participate in the event announced by the event-associated message 521 is not limited to the above example embodiments. The intention to participate may be input using various methods.

When a guest user inputs an intention to participate in a specific event, information on the event and/or information on the guest user may be transmitted to the host user who has created the event.

When input of the guest user is received in response to the transmitted event-associated message, a message requesting remittance, that is, a remittance request message, may be transmitted to the guest user based on the input (S330). At this time, the input of the guest user may include an intention to participate in the event.

The processor 210 of the host user device may receive information on the guest user who has input the intention to participate in the event and/or the information on the event through the transceiver 230. The processor 210 may generate the remittance request message based on the information on the event. The remittance request message may display, for example, an event participation fee and a due date for payment and request that the membership fee be remitted by the due date.

The remittance request message may be transmitted to the guest user who has input the intention to participate in the event. At this time, the received information on the guest user may be used. The remittance request message may be displayed on the chat room of the guest user who has input the intention to participate, thereby inducing remittance of the membership fee.

A right chat window 530 of FIG. 5 is an example of a chat window of a guest user, in which the received remittance request message 531 is displayed. As shown in FIG. 5, the remittance request message 531 may include the information on the event and content that induces remittance of the membership fee. Further, the remittance request message 531 may include information on an account that will receive remittance. When there is a remittance and payment service available through the messenger application, the remittance request message 531 may include a “pay” button or link for executing the remittance service.

The remittance request message 531 may be transmitted through a second chat room different from the first chat room in which the event-associated message 521 is transmitted. For example, the first chat room in which the event-associated message 521 is announced may include both a guest user who participates in the event and a guest user who does not participate in the event. If the remittance request message 531 is transmitted through the first chat room in which the event-associated message 521 is transmitted, the guest user who does not participate in the event may also be inappropriately requested to remit the membership fee. Further, when a time for displaying the transmitted remittance request message 531 in the chat window is short due to active communication through the first chat room, transmission of the remittance request message 531 through the first chat room may not be appropriate. For example, for the same reason as described above, the remittance request message 531 may be transmitted through the second chat room different from the first chat room in which the event-associated message 521 is transmitted.

The second chat room in which the remittance request message 531 is transmitted may be an existing chat room in which the guest user who has indicated the intention to participate in the event are participating. In some example embodiments, the processor 210 of the host user device or the guest user device may generate the second chat room including the guest user who has indicated the intention to participate in the event and transmit the remittance request message 531 through the generated second chat room. At this time, the processor 210 of the host user device may use the received information on the guest user in order to identify the guest user who has indicated the intention to participate in the event. The second chat room may include both the guest user and the host user. In some example embodiments, for example, the second chat room may include a plurality of guest users who have indicated the intention to participate in the event and the host user.

In some example embodiments, the remittance request message 531 may be transmitted through the first chat room in which the event-associated message 521 is transmitted. As described above, when it is not desired to transmit the remittance request message 531 and the event-associated message 521 through different chat rooms, the remittance request message 531 and the event-associated message 521 may be transmitted through the same chat room. For example, in the case where transmission of the remittance request message 531 using the same chat room is possible, such as in the case where the number of guest users participating in the first chat room is equal to or less than a certain number or is in a certain range on a social graph, in the case where the remittance request message 531 is capable of being always displayed in the chat window separately from communication in the chat room (e.g., the case where the remittance request message 531 is fixed and displayed at the top of the chat room when an announcement function provided by a messenger application is used), etc., the event-associated message 521 and the remittance request message 531 may be transmitted through the same chat room.

Whether the event-associated message 521 and the remittance request message 531 are transmitted through the same chat room or different chat rooms may be predetermined or may be set by the host user. In some example embodiments, whether to use the same chat room or different chat rooms may be determined according to the nature of the chat room. For example, in the case of an open chat room with no restrictions on qualification to participate in the chat room, it may be determined that the event-associated message 521 and the remittance request message 531 are transmitted through different chat rooms. In some example embodiments, for example, in the case of a group chat room in which there is a restriction on qualification for participation or only a small number of users is highly likely to participate like an alumni association, it may be determined that the event-associated message 521 and the remittance request message 531 are transmitted through the same chat room. In some example embodiments, whether the event-associated message 521 and the remittance request message 531 are transmitted through the same chat room or different chat rooms may be determined based on a combination of two or more of the above-described example embodiments.

The guest user who has received the remittance request message 531 may process the requested remittance. For example, remittance may be processed using the remittance and payment service supported by the messenger application or may be processed through a banking application separately from the messenger application.

For example, the guest user may execute the remittance and payment service supported by the messenger application by clicking the “pay” button included in the remittance request message 531, and process remittance using the service. Further, even if information such as account number is not displayed in the remittance request message 531, an account number associated with the remittance request message 531 may be automatically designated and remittance to the associated account number may be processed when the “pay” button included in the remittance request message 531 is clicked.

The processor 210 of the host user device may determine whether remittance requested by the transmitted remittance request message is processed (S340).

When remittance is processed using the remittance and payment service supported by the messenger application, whether the requested remittance has been processed may be determined by data transmission and reception between the messenger application and the remittance and payment service.

When remittance is processed using the banking application separately from the messenger application, the processor may check information on whether the requested remittance has been processed based on information acquired by manipulation of the guest user. The information may be, for example, remittance processing information generated by the banking application.

In some example embodiments, the processor 210 of the host user device may continuously monitor the account to receive remittance and identify a guest user who has remitted the membership fee when remittance to the account is processed, thereby determining whether to process remittance from the guest user.

The processor 210 of the host user device may determine whether the remittance requested by the remittance request message has been processed, and then transmit a subsequent message to the guest user based on this (S350).

The determination as to whether the remittance has been processed is not limited to the above-described method and various methods may be used. For example, the host user may determine whether the remittance has been processed by receiving the history of the account associated with the event-associated message input when generating the event-associated message. In some example embodiments, whether the remittance has been processed may be determined by analyzing a remittance related message received from a mobile banking official account (OA) through a messenger. When the remittance requested by the remittance request message has not been processed by the guest user device, the processor 210 of the host user device may generate a reminder message as a subsequent message and transmit the reminder message to the guest user device by which the remittance requested by the remittance request message has not been processed. When the remittance of the remittance request message has been processed by the guest user device, the processor 210 of the host user device may generate a remittance confirmation message as a subsequent message and transmit the remittance confirmation message to the guest user device by which the remittance requested by the remittance request message has been processed.

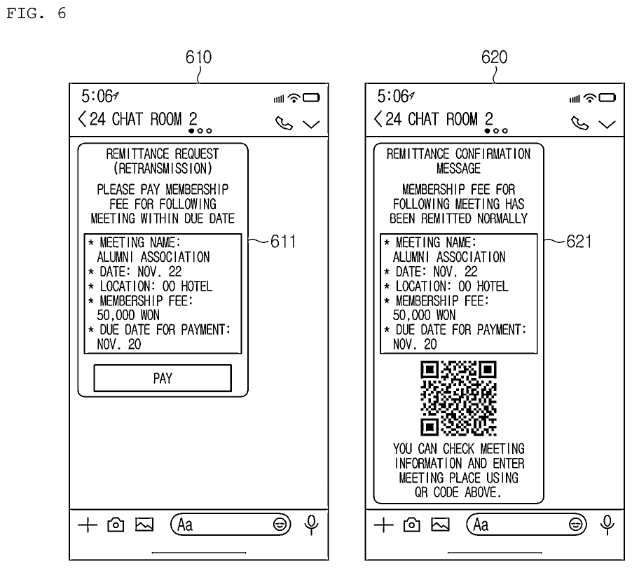

FIG. 6 is a view showing a reminder message and a remittance confirmation message transmitted according to an example embodiment of the present disclosure.

For example, as shown in a left chat window 610 of FIG. 6, the reminder message 611 may be transmitted by retransmitting the remittance request message to the guest user who has not processed the remittance requested by the remittance request message. The reminder message 611 may be transmitted through the same chat room as the chat room in which the remittance request message 531 is transmitted.

However, example embodiments of the present disclosure are not limited to the above example. In some example embodiments, the reminder message 611 may be transmitted through a chat room different from the chat room in which the remittance request message 531 is transmitted, or a separate chat room for transmitting the reminder message 611 may be generated.

The format of the reminder message 611 is not limited to the example shown in FIG. 6 and any format of information urging the payment of the membership fee for a specific event may be included in the reminder message according to the present disclosure.

As shown in FIG. 6, some or all of the reminder messages 611 may be the same as the remittance request message 531, and the description of the same content or function is the same as the description of the remittance request message 531 and thus will be omitted below.

Further, as shown in in a right chat window of FIG. 6, a remittance confirmation message 621 may be transmitted to the guest user who has processed remittance. The remittance confirmation message 621 may be transmitted through the same chat room as the chat room in which the remittance request message 531 is transmitted.

However, example embodiments of the present disclosure are not limited to the above example. In some example embodiments, the remittance confirmation message 621 may be transmitted through a chat room different from the chat room in which is transmitted, or a separate chat room for transmitting the remittance confirmation message 621 may be generated.

The format of the remittance confirmation message 621 is not limited to the example shown in FIG. 6 and any format of information for confirming the payment of the membership fee for a specific event may be included in the remittance confirmation message 621 according to the present disclosure.

As shown in FIG. 6, the remittance confirmation message 621 may include brief information on the associated event and information confirming the payment of the membership fee for the event. Further, the remittance confirmation message 621 may include approval information for approving participation in the event. For example, the remittance confirmation message 621 may include a QR code as approval information. The QR code included in the remittance confirmation message 621 may be used to confirm the information on the event or to check permission to enter an event place.

As described with reference to FIGS. 3, 5 and 6, the host user may create an event and efficiently manage payment of the participation fee for the event. Further, according to the present disclosure, the host user may receive information on whether remittance requested by the remittance request message has been processed. For example, the host user may manage a list of guest users who have indicated the intention to participate in a specific event, thereby efficiently managing whether remittance processing is completed.

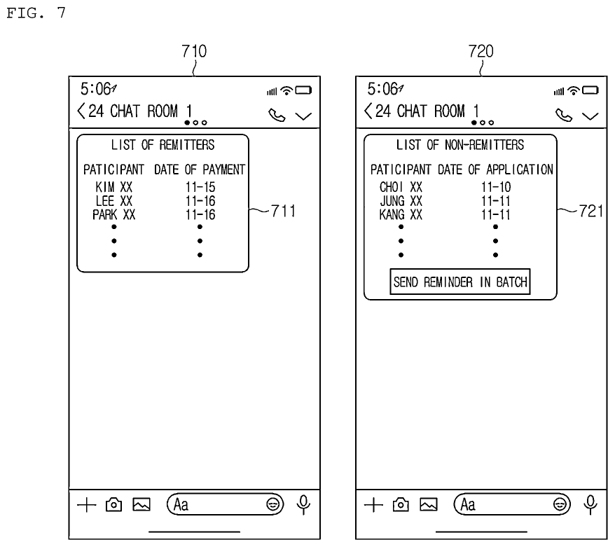

FIG. 7 is a view showing a list of guest users which may be provided to a host user according to an event managing method of an example embodiment of the present disclosure.

For example, according to an event managing method of the present disclosure, the host user may receive the list of guest users who have indicated the intention to participate in the specific event, that is, a list of participants. For example, the processor 210 of the host user device may receive the event-associated message, generate a list of participants including guest users who have input the intention to participate, and store the list in the memory 220. When a new guest user applies for participation, the guest user may be added, thereby updating the list of participants. Further, when a guest user included in the list of participants withdraws an intention to participate, the guest user may be removed from the list of participants or a separate mark (intention withdrawal mark) may be marked on the list of participants, thereby updating the list of participants.

Further, according to an event managing method of the present disclosure, the host user may receive a list of guest users who have completed remittance of a specific event, that is, a list of remitters. For example, the processor 210 of the host user device may generate a list including guest users who have completed remittance as a result of (e.g., based on) determination of operation S340 and store the list in the memory 220. Whenever there is a guest user who is confirmed to have completed remittance in operation S340, the guest user may be added, thereby updating the list of remitters. Further, when a guest user included in the list of remitters withdraws remittance, the guest user may be removed from the list of remitters or a separate mark (remittance withdrawal mark) may be marked on the list of remitters, thereby updating the list of remitters.

In some example embodiments, whenever it is determined that remittance is completed as a result of (e.g., based on) determination of operation S340, the above-described list of participants may be updated. That is, completion of remittance of the guest user may be recorded on the list of participants. In this case, the processor 210 of the host user device may generate the list of remitters, by reconfiguring the list to include only the guest users recorded as completing remittance among the guest users included in the list of participants. For example, as shown in a left chat window 710 of FIG. 7, a list 711 of remitters may be provided to the host user.

Further, according an the event managing method of the present disclosure, the host user may receive a list of guest users who have not completed remittance for a specific event, that is, a list of non-remitters. The list of non-remitters may be generated by reconfiguring the list to include only the guest users recorded as not completing remittance among the guest users included in the list of participants. In some example embodiments, after the same list as the list of participants is generated, the guest user who is confirmed to complete remittance in operation S340 may be removed from the list or a separate mark may be marked, thereby updating the list of non-remitters. The separately generated list of non-remitters may be updated by adding a participant, completing remittance, withdrawing application for participation or withdrawing remittance. For example, as shown in a right chat window 720 of FIG. 7, the list of non-remitters 721 may be provided to the host user. The list of non-remitters 721 may include, for example, an additional function such as a “send reminder in a batch”. The host user may send the reminder message in a batch (lump) to all guest users included in the list of non-remitters 721, by executing the function. In some example embodiments, a function for sending the reminder message to each or some of the guest users included in the list of non-remitters 721 may be included.

The host user may receive the list using a function for displaying the above-described lists (the list of participants, the list of remitters, the list of non-remitters, etc.). For example, the function may be implemented as a function provided in the messenger application installed in the host user device or in an individual chat room of the messenger application. When the host user executes the function, the processor 210 may read the requested list from the memory 220 and provide the list to the host user. For example, the requested list may be provided through the chat window of the chat room. At this time, the chat room in which the list is displayed may be the same chat room as the chat room in which the event-associated message is transmitted. However, example embodiments of the present disclosure are not limited thereto. In some example embodiments, a separate chat room may be generated to display the list. As a specific example, if the host user and the management of a first chat room, to which the guest user belongs, are present as determined in advance, the list of non-remitters 721 may be provided through a chat room including only the host user and the management of the first chat room. At this time, the above-described lists (the list of participants, the list of remitters, the list of non-remitters, etc.) may be displayed in various forms such as a popup window through a menu or notification.

Some or all of operations of the event managing method according to an example embodiment of the present disclosure described with reference to FIG. 3 may be performed by the server 260. When each operation of the event managing method of FIG. 3 is performed in the server 260, the operation of the host user device in the operation may be understood as being performed in the server 260. Further, the description that is not related to change of the subject for performing each operation in the description of the host user device is equally applied to the server 260.

Operation S310 of creating the event-associated message of FIG. 3 may be performed in the server 260 based on an input of the host user. For example, when the host user inputs information on an event to be generated through the input unit 240 of the host user device, the information may be transmitted to the server 260. The server 260, which has received the information on the event, may create the event-associated message according to the present disclosure using the information.

Operation S320 of transmitting the event-associated message of FIG. 3 may be performed in the server 260. When the event-associated message is generated in the host user device, the server 260 may receive the generated event-associated message and transmit the received event-associated message to at least one guest user device through the messenger application. When the event-associated message is generated in the server 260, the server 260 may transmit the generated event-associated message to at least one guest user device through the messenger application. At this time, the event-associated message may be transmitted through a chat room including the host user and at least one guest user. At this time, the event-associated message transmitted from the host user to at least one guest user included in the same chat room may be displayed in a chat window.

Operation S330 of transmitting the remittance request message of FIG. 3 may be performed in the server 260. The server 260 may receive information including an intention to participate in a specific event from a guest user device. The information may include information on the event and information on the guest user who has indicated the intention to participate. The server 260 may identify the event and the guest user based on the received information. Further, the server 260 may transmit the remittance request message for the event to the guest user through the messenger application. The remittance request message may be generated in the host user device, or maybe generated in the server 260 based on the information on the event. The server 260 may store the generated remittance request message in the memory 270, and read the related remittance request message from the memory 270 and transmit the related remittance request message to the guest user device, when an intention to participate is received from the guest user later. In some example embodiments, the server 260 may generate and transmit the related remittance request message to the guest user device, when an intention to participate is received from the guest user. The information on the event or the remittance request message may be stored in the memory 270 of the server 260 together with event identification information. The remittance request message may be transmitted through the chat room including the guest user, as described above. To this end, the server 26 may generate or identify a chat room including the guest user and transmit the remittance request message through the chat room. For example, the server 260 may generate a chat room including the host user and the guest user and transmit the remittance request message through the chat room. At this time, the remittance request message transmitted from the host user to at least one guest user included in the same chat room may be displayed in the chat window of the host user and the chat window of the guest user.

Operation S340 of determining whether remittance has been processed of FIG. 3 may be performed in the server 260. When remittance is processed using the remittance and payment service supported by the messenger application, the server 260 may receive remittance data from the remittance and payment service, thereby determining whether remittance has been processed. When remittance is processed using a banking application separate from the messenger application, the server 260 may determine whether remittance has been processed based on remittance processing information received from the guest user. In some example embodiments, the server 260 may receive a history of an account identified by the information on the event, thereby determining whether remittance has been processed. In some example embodiments, the server 260 may analyze a remittance related message received from an official account of mobile banking through the messenger application, thereby determining whether remittance has been processed. The server 260 may store a result of determining whether remittance has been processed in the memory 270, such that the result may be used to generate a list related to the event later.

Operation S350 of transmitting the subsequent message of FIG. 3 may be performed in the server 260. When remittance has not been processed in response to the remittance request message in operation S340, the server 260 may transmit the reminder message to the guest user. In some example embodiments, when remittance has been processed in response to the remittance request message in operation S340, the server 260 may transmit a remittance confirmation message to the guest user. The subsequent message may be generated in the host user device or the server 260. The server 260 may store the generated subsequent message in the memory 270, and read the related subsequent message from the memory 270 and transmit the remitted subsequent message to the guest user device, according to a result of determining whether remittance has been processed later. In some example embodiments, when it is determined whether remittance has been processed, the server 260 may generate and transmit a related subsequent message to the guest user device. When information included in the subsequent message (e.g., the QR code included in the remittance confirmation message) differs between guest users, the subsequent message or information included in the subsequent message may be generated with respect to a respective guest user after determining whether remittance has been processed. The subsequent message may be stored in the memory 270 of the server 260 together with event identification information.

The above-described list (the list of participants, the list of remitters, the list of non-remitters, etc.) or information desired to generate the list may be stored in the memory 270 of the server 260. Further, operation performed by the host user device in relation to generation and update of the list may be performed by the server 260, thereby generating the list or updating the list stored in the memory 270. When a request is received from the host user, the server 260 may generate or read the list (the list of participants, the list of remitters, the list of non-remitters, etc.) from the memory 270 and transmit the list to the host user device. The transmitted list may be displayed through the output unit 250 of the host user device in various forms such as a popup through a menu or notification.

### Event Participation Method

An event participation method according to an example embodiment of the present disclosure may be performed through a messenger application installed in a guest user device.

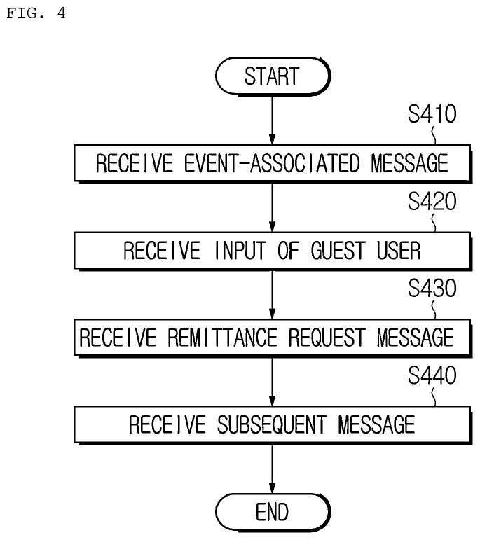

Hereinafter, an event participation method according to the present disclosure will be described with reference to FIG. 4.

FIG. 4 is a view illustrating an event participation method according to an example embodiment of the present disclosure.

The event participation method according to the example embodiment of the present disclosure may include receiving an event-associated message (S410), receiving guest user input (S420), receiving a remittance request message (S430) and/or receiving a subsequent message (S440).

The event participation method of FIG. 4 may be performed in the guest user device. Further, the event participation method of FIG. 4 may include operations corresponding to the operations of the event managing method of FIG. 3. Hereinafter, a portion of the description of the event participation method of FIG. 4 overlapping the event managing method of FIG. 3 will be omitted.

According to the event participation method of FIG. 4, the guest user device may receive the event-associated message (S410). For example, the event-associated message related to participation in a desired (or alternatively, predetermined) event transmitted to the guest user through a first chat window, to which a host user and the guest user belong, may be received. For example, the processor 210 of the guest user device may receive the event-associated message from the host user device through the transceiver 230. The received event-associated message 521 may be displayed on the output unit 250 of the guest user device as shown by reference numeral 520 of FIG. 5, thereby being provided to the guest user.

The guest user device may receive input of the guest user in response to the received event-associated message 521 (S420). For example, the guest user may apply for participation in the event of the event-associated message 521 through the input unit 240 of the guest user device, and the guest user device may receive the application for participation as input.

When the application for participation in the specific event is received from the guest user, the guest user device may receive the remittance request message for the event (S430). For example, the processor 210 of the guest user device may receive the remittance request message for the event through the transceiver 230. The received remittance request message 531 may be displayed on the output unit 250 of the guest user device as shown by reference numeral 530 of FIG. 5, thereby being provided to the guest user.

The guest user, who has received the remittance request message, may process remittance using various remittance and/or payment methods. As described above, the event managing method according to some example embodiments may include transmitting the subsequent message depending on whether the guest user has processed remittance requested by the remittance request message.

The guest user device may receive the subsequent message (S440). For example, when remittance is completed, the processor 210 of the guest user device may receive the remittance confirmation message 621 through the transceiver 230 as the subsequent message. For example, when remittance is not completed, the processor 210 of the guest user device may receive the reminder message 611 through the transceiver 230 as the subsequent message.

Although not shown, the guest user device may display a list of messages for which remittance has not been processed, among the received remittance request messages. The remittance request message received by each guest user and/or whether to process remittance may be managed as a list. The list may be stored in the memory of the guest user device or managed. In some example embodiments, the list may be stored in the memory of the server 260 or managed. The list may be displayed on the output unit 250 of the guest user device in various forms such as a popup window through a menu or notification of the messenger application.

According to some example embodiments of the present disclosure, opening of an event and management of membership fees for the event may be efficiently performed. For example, all procedures related to payment of the membership fees may be performed on a messenger application, and various lists related to participants of the event can be provided, thereby efficiently managing the event. In addition, a guest user who has applied to participate in the event may also receive a remittance request message and a reminder or remittance confirmation message through the messenger application, thereby efficiently performing an event participation procedure.

According to some example embodiments of the present disclosure, a computing device may implement an event managing method and/or an event participation method through an instant messenger application (e.g., a group chat room supported by an instant messenger application), without executing additional application(s) or program instructions, thereby using less computing resource and consuming less power.

Although the example methods of the present disclosure are represented by a series of operations for clarity of description, example embodiments are not intended to limit the order in which the operations are performed. That is, if desired, each operation may be performed in parallel or performed in series in a different order. The example embodiments described above can be modified such that some additional operations can be added to a corresponding example embodiment or some existing operations can be eliminated from a corresponding example embodiment.

The various example embodiments described above are not intended to represent all of the possible combinations according to technical spirit of the present disclosure but are provided only for illustrative purposes. Elements or operations described in the above various embodiments can be applied independently or in combination.

Methods according to example embodiments may be implemented with program instructions that can be executed by various computing devices, and can be recorded in a computer-readable recording medium. The computer-readable recording medium may store program instructions, data files, data structures, and the like solely or in combination. The program instructions recorded on the medium may be ones that are specifically designed and configured to carry out the present invention or may be publicly available to professionals in the field of computer software. Examples of the computer-readable recording medium include magnetic media such as hard disks, floppy disks, and magnetic tapes, optical media such as CD-ROMs and DVDs, magneto-optical media such as floptical disks, and hardware devices, which are specifically configured to store and execute program instructions, such as ROM, RAM, and flash memory. Examples of the program instruction include machine language codes generated by a compiler and high-level language codes that are generated by an interpreter, and can be executed by a computer. The hardware device described above may be configured to include at least one software module to perform a method according to an example embodiment, and vice versa.

Various example embodiments in the present disclosure can be implemented by hardware, firmware, software, or a combination thereof. When implemented by hardware, some example embodiments can be implemented by at least one application specific integrated circuit (ASIC), digital signal processor (DSP), digital signal processing device (DSPD), programmable logic device (PLD), field programmable gate array (FPGA), general processor, controller, micro controller, or micro-processor.

The scope of the present disclosure covers a non-transitory computer-readable medium in which software or machine-executable commands (e.g., operating systems (OSs), application programs, firmware, programs) that, when executed by a certain device or computer, enable the certain device or computer to perform operations according to various example embodiments are stored.

What is claimed is:

1. An event managing method performed by a computing device of a host user, the computing device comprising at least one processor, the event managing method comprising:
generating, by the at least one processor, an event-associated message based on input information on an event from the host user through a messenger application installed in the computing device, the event-associated message including a graphical user interface to allow a guest user to indicate an intention to participate in the event therethrough;
displaying, by the at least one processor, the event-associated message to be accessible to a plurality of guest user devices of a plurality of guest users in the messenger application regardless of a social graph of the plurality of guest users;
in response to receiving a response message indicating the intention of a first guest user of the guest users to participate in the event from a first guest user device of the guest user devices, determining, by the at least one processor, whether a private chat room for the host user and the first guest user in the messenger application exists;
generating, by the at least one processor, the private chat room in the messenger application, in response to the private chat room not existing, wherein the private chat room is not accessible to another guest user except the first guest user;
transmitting, by the at least one processor, a remittance request message to the first guest user device through the private chat room;
generating, by the at least one processor, a specific linked code in response to a remittance requested by the remittance request message being processed, wherein the specific linked code is personalized to the first guest user; and
transmitting, by the at least one processor, a subsequent message including the specific linked code and through the private chat room wherein the subsequent message is associated with event identification information.

2. The event managing method of claim 1, wherein the event-associated message or the remittance request message comprises information on a participation fee of the event or a due date for the remittance.

3. The event managing method of claim 1, further comprising:
re-transmitting, by the at least one processor, another remittance request message to the first guest user device in response to determining that the remittance requested by the remittance request message has not been processed by the first guest user device.

4. The event managing method of claim 1, wherein the subsequent message comprises information acknowledging receipt of the remittance requested by the remittance request message, in response to the remittance having been processed.

5. The event managing method of claim 4, wherein the subsequent message further comprises information indicating that a participation of the first guest user in the event has been approved.

6. The event managing method of claim 1, wherein information on whether the remittance requested by the remittance request message has been processed is provided to the computing device of the host user.

7. The event managing method of claim 1, further comprising:
in response to receiving a response message indicating the intention of a second guest user of the guest users to participate in the event from a second guest user device of the guest user devices, determining, by the at least one processor, whether another private chat room including only the host user and the second guest user in the messenger application exists;
generating, by the at least one processor, the another private chat room in the messenger application, in response to the another private chat room not existing, the another private chat room is not accessible to the first guest user;
transmitting, by the at least one processor, another remittance request message to the second guest user device through the another private chat room;
generating, by the at least one processor, another specific linked code in response to a remittance requested by the another remittance request message being processed, wherein the another specific linked code is personalized to the second guest user and different from the specific linked code for the first guest user; and
transmitting, by the at least one processor, another subsequent message including the another specific linked code through the another private chat room.

8. The event managing method of claim 1, wherein the generating the private chat room in the messenger application further comprises generating the private chat room in response to a number of the guest users in a chat room, in which the event-associated message is displayed, exceeding a predetermined number.

9. The event managing method of claim 1, wherein the generating the private chat room in the messenger application further comprises generating the private chat room in response to a range of the social graph among the guest users in a chat room, in which the event-associated message is displayed, being out of a predetermined range.

10. The event managing method of claim 1, wherein the transmitting a remittance request message comprises transmitting the remittance request message associated an account number for the event without displaying the account number on the first guest user device.

11. The event managing method of claim 1, wherein the remittance requested by the remittance request message has been processed using a remittance and payment service supported by the messenger application or a banking application separately from the messenger application.

12. The event managing method of claim 1, wherein the generating a specific linked code further comprises monitoring whether remittance requested by the remittance request message has been processed.

13. The event managing method of claim 1, wherein the generating a specific linked code further comprises determining whether remittance requested by the remittance request message has been processed by analyzing a remittance-related-message received from a mobile banking official account through the messenger application.

14. A non-transitory computer-readable recording medium having recorded thereon a program for execution by at least one processor included in a computing device of a host user, that when executed by the at least one processor causes the computing device to perform an event managing method, the event managing method comprising:
generating, by the at least one processor, an event-associated message based on input information on an event from the host user through a messenger application installed in the computing device, the event-associated message including a graphical user interface to allow a guest user to indicate an intention to participate in the event therethrough;
displaying, by the at least one processor, the event-associated message to be accessible to a plurality of guest user devices of a plurality of guest users in the messenger application regardless of a social graph of the plurality of guest users;
in response to receiving a response message indicating the intention of a first guest user of the guest users to participate in the event from a first guest user device of the guest user devices, determining, by the at least one processor, whether a private chat room for the host user and the first guest user in the messenger application exists;
generating, by the at least one processor, the private chat room in the messenger application, in response to the private chat room not existing, wherein the private chat room is not accessible to another guest user except the first guest user;
transmitting, by the at least one processor, a remittance request message to the first guest user device through the private chat room;
generating, by the at least one processor, a specific linked code in response to a remittance requested by the remittance request message being processed, wherein the specific linked code is personalized to the first guest user; and
transmitting, by the at least one processor, a subsequent message including the specific linked code and through the private chat room wherein the subsequent message is associated with event identification information.

15. A computing device of a host user comprising:
at least one processor configured to,
generate an event-associated message based on input information on an event from the host user through a messenger application installed in the computing device, the event-associated message including a graphical user interface to allow a guest user to indicate an intention to participate in the event,
display the event-associated message to be accessible to plurality of guest user devices of a plurality of guest users in the messenger application regardless of a social graph of the plurality of guest users,
determine whether a response message indicating the intention of a first guest user of the guest users to participate in the event through the event-associated message is received from the guest user device through a first chat room,
determine whether a private chat room for the host user and the first guest user in the messenger application exists in response to receiving a response message indicating the intention of the first guest user of the guest users to participate in the event from a first guest user device of the guest user devices,
generate the private chat room in the messenger application, in response to the private chat room not existing, wherein the private chat room is not accessible to another guest user except the first guest user,
transmit a remittance request message to the first guest user device through the private chat room,
generate a specific linked code in response to a remittance requested by the remittance request message being processed, wherein the specific linked code is personalized to the first guest user, and
transmit a subsequent message including the specific linked code and through the private chat room wherein the subsequent message is associated with event identification information.

16. The computing device of claim 15, wherein the event-associated message or the remittance request message comprises information on a participation fee of the event or a due date for the remittance.

17. The computing device of claim 16, wherein the processor is further configured to re-transmit another remittance request message to the first guest user device in response to determining that the remittance requested by the remittance request message has not been processed by the first guest user device.

18. The computing device of claim 16, wherein the subsequent message comprises information acknowledging receipt of the remittance requested by the remittance request message, in response to the remittance having been processed.

19. The computing device of claim 18, wherein the subsequent message further comprises information indicating that a participation of the first guest user in the event has been approved.

20. The computing device of claim 16, wherein the processor is further configured to provide information on whether the remittance requested by the remittance request message has been processed to the computing device of the host user.
